(19) United States
(12) Patent Application Publication
(10) Pub. No.: US 2019/0264686 A1
(43) Pub. Date: Aug. 29, 2019

(54) VACUUM-PUMP ROTOR

(71) Applicant: Leybold GmbH, Köln (DE)

(72) Inventors: Thomas Dreifert, Kerpen (DE); Dirk Schiller, Hürth (DE); Wolfgang Giebmanns, Erftstadt (DE); Roland Müller, Köln (DE)

(21) Appl. No.: 16/326,041

(22) PCT Filed: Aug. 11, 2017
(86) PCT No.: PCT/EP2017/070447

§ 371 Date: May 13, 2019

(30) Foreign Application Priority Data
Aug. 30, 2016 (DE) 20 2016 005 207.2

(51) Int. Cl. F04C 3/00; F04C 15/00

(52) U.S. Cl. CPC F04C 3/00; F04C 15/00; F04C 2240/20; F04C 2250/20; F05C 2253/12; F05C 2201/021; F05C 2201/903; F05C 2201/0448; F05C 2251/042; F04C 2220/10

(57) ABSTRACT

A vacuum pump rotor comprises at least one displacement element arranged on a rotor shaft. The rotor shaft comprises at least one shaft end for a bearing element to be arranged thereon. The rotor element, the at least one displacement element and the at least one shaft end are made from aluminum or an aluminum alloy.

### BACKGROUND

### 1. Field of the Disclosure

The disclosure relates to a vacuum pump rotor, in particular for screw pumps, claw pumps, Roots pumps and multistage claw and Roots pumps.

### 2. Discussion of the Background Art

Rotors are usually made from steel or cast iron. Here, the rotor comprises a rotor shaft having one or a plurality of displacement elements, wherein the displacement elements are of different configurations according to the pump type. Here, the rotor shaft and the displacement elements are integrally formed from steel or cast iron. Due to the hardness of steel and cast iron, the processing of the corresponding vacuum pump rotors, for producing a helical groove on a rotor for a screw pump, for example, is complicated and expensive. In particular, high tooling costs are involved.

Further, vacuum pump rotors for screw pumps are known, where the shaft is made from steel and supports a displacement element made from aluminum. Vacuum pump rotors from different materials involve a considerable manufacturing effort since the two components must be joined together and further, due to the high temperatures occurring at vacuum pumps, due to the different thermal expansion coefficients of the materials precise cooling must be ensured.

It is an object of the disclosure to provide a vacuum pump rotor which is highly reliable and involves low manufacturing costs.

### SUMMARY

The vacuum pump rotor according to the disclosure comprises a rotor shaft on which at least two displacement elements are arranged. Depending on the rotor type, the displacement elements are in particular displacement elements for screw pumps, claw pumps, Roots pumps or multistage claw and Roots pumps. The rotor shaft comprises at least one shaft end for bearing elements to be arranged thereon. When the rotor shaft is configured with only one shaft end, these are overhung vacuum pump rotors. In the case of overhung vacuum pump rotors at least two bearing elements are provided. Likewise, the rotor shaft may comprise two shaft ends such that a bearing element is arranged at each shaft end for two-sided mounting.

According to the disclosure, the rotor shaft, the at least one displacement element and the shaft ends of the rotor shaft are made from aluminum or an aluminum alloy. According to the disclosure, thus the entire vacuum pump rotor is made from one and the same material. Thereby, the manufacturing costs can be considerably reduced since processing of aluminum and aluminum alloys is less expensive. In particular, the tooling costs are lower.

Even if the displacement elements are separately manufactured and joined together with the rotor shaft, this is easier to be performed during the manufacturing process since the expansion coefficients of the two components are identical. Therefore, there is no risk that the connection is disconnected in the case of temperature changes. This is true even if the individual components are made from different aluminum alloys, since the two expansion coefficients only slightly differ from each other.

According to a particularly preferred embodiment, the rotor shaft is integrally formed with at least one of the displacement elements. In addition, it is preferred that all displacement elements are integrally formed with the rotor shaft. This offers the advantage that the components need not be joined together. In addition, it is preferred that the at least one shaft end is integrally formed with the rotor shaft.

Preferably, for the rotor shaft, the at least one displacement element and the at least one shaft end aluminum or an aluminum alloy is used which has a thermal expansion coefficient of smaller than or equal to 21×10⁻⁶/K, and preferably smaller than or equal to 18×10⁻⁶/K. As an aluminum alloy, preferably AlSi9Mg or AlSi17Cu4Mg is used. It is particularly preferred that the alloy has a large silicon content of preferably at least 15%.

According to another preferred embodiment, in particular wear-critical surfaces of the at least one displacement element and/or the rotor shaft and/or the shaft ends are provided with a wear-reducing coating. This may be an anodic coating, for example. The coating may be chromic or sulfuric, anodized or hard-coated.

According to another preferred embodiment, at the at least one shaft end a bushing from a harder material, in particular steel or a ceramic material, is arranged. Thereby, wear is reduced in particular in an area strongly prone to wear.

The bushing can be pressed onto the at least one shaft end or molded into the shaft end during the manufacture.

According to another preferred embodiment, a surface of the at least one displacement element is provided with an emergency operation coating. Here, it is preferred that only those surfaces of the displacement element are provided with such a coating, which may come into contact with another displacement element during operation. Provision of such an emergency operation coating on the basis of PTFE or molybdenum sulfite, for example, offers the advantage that the coating shrinks when two displacement elements contact each other and thus seizure of the vacuum pump rotors is prevented. Further, provision of such a coating reduces the gap height, i.e. the gap between components causing the compression, such as between two screw rotors or between the outside and the inside of a rotor. Due to the reduced gap height the suction capacity of the vacuum pump and the attainable final pressure increase. The temperatures and the power consumption are reduced.

### BRIEF DESCRIPTION OF THE DRAWINGS

Hereunder the disclosure is explained in detail on the basis of a preferred embodiment with reference to the accompanying drawing in which:

FIG. 1 shows a schematic side view of a screw rotor.

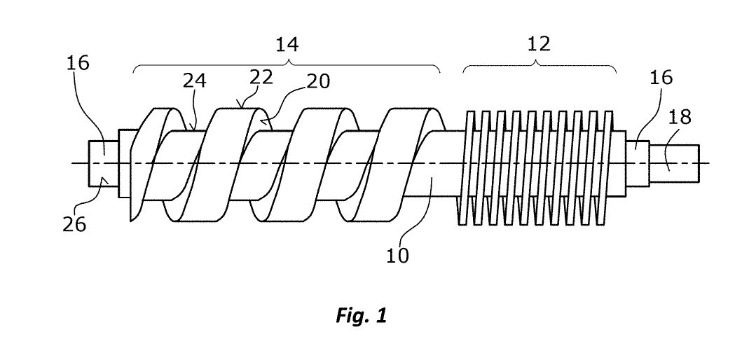

### DETAILED DESCRIPTION OF THE PREFERRED EMBODIMENT

Hereunder the disclosure is described on the basis of an exemplary screw rotor, wherein the disclosure is in particular also applicable to rotors for claw pumps, Roots pumps and multistage claw and Roots pumps.

In the illustrated exemplary embodiment, a vacuum pump rotor of a screw pump comprises a rotor shaft 10 on which two displacement elements 12, 14 are arranged. In particular, the rotor shaft 10 and the displacement elements 12, 14 are integrally formed. In the illustrated exemplary embodiment, the two displacement elements 12, 14 have different pitches, wherein the displacement element 14 having a larger pitch is connected to the inlet of the vacuum pump on the left-hand side in the Figure and the displacement element 12 having the smaller pitch is connected to the outlet of the vacuum pump on the right-hand side in the Figure.

In the illustrated exemplary embodiment, the rotor shaft 10 comprises two shaft ends 16 since this is a vacuum pump rotor mounted on both sides in the illustrated exemplary embodiment. The two shaft ends 16 serve for accommodating bearing elements. The two shaft ends 16 may additionally be provided with a bushing not illustrated which is in particular made from a harder material. The bushing may be pressed onto or molded into the shaft ends.

The illustrated vacuum pump rotor is preferably formed as a single piece such that the shaft 10 including the shaft ends 16 and the two displacement elements 12, 14 is made from one material, in particular aluminum or an aluminum alloy.

Further, the illustrated vacuum pump rotor comprises a shaft projection 18. The latter serves for accommodating a gearwheel, for example, via which the rotor shaft 10 is driven or possibly synchronized with the second screw pump rotor. Preferably, the projection 18 is also integrally formed with the shaft 10 and made from the same material.

Surfaces 20, 22 of the displacement element 14 may be provided with a wear-reducing coating and/or a coating imparting emergency operation properties. This is also possible on a surface 24 of the rotor shaft 10. Of course, corresponding coatings may also be provided on the displacement element 12.

If the shaft ends 16 are not provided with a bushing, it is preferred to provide the surface 26 of the shaft ends 16 with a wear-reducing coating.

What is claimed:

1. A vacuum pump rotor, comprising
at least one displacement element arranged on a rotor shaft,
wherein said rotor shaft comprises at least one shaft end for a bearing element to be arranged thereon,
wherein
said rotor shaft, said at least one displacement element and said at least one shaft end are made from aluminum or an aluminum alloy.

2. The vacuum pump rotor according to claim 1, wherein on the rotor shaft at least two displacement elements are arranged.

3. The vacuum pump rotor according to claim 1, wherein the rotor shaft and at least one of the displacement elements are integrally formed.

4. The vacuum pump rotor according to claim 1, wherein the rotor shaft and all displacement element are integrally formed.

5. The vacuum pump rotor according to claim 1, wherein the aluminum used or the aluminum alloy used has a thermal expansion coefficient which is smaller than or equal to 21×10⁻⁶/K.

6. The vacuum pump rotor according to claim 1, wherein the aluminum alloy used comprises a high silicon content of about least 15%.

7. The vacuum pump rotor according to claim 1, wherein the surface of the at least one displacement element and/or the rotor shaft is provided with a wear-reducing coating.

8. The vacuum pump rotor according to claim 1, wherein the at least one shaft end comprises a bushing from a harder material, in particular steel or a ceramic material.

9. The vacuum pump rotor according to claim 8, wherein the bushing is pressed onto the at least one shaft end or is molded into said at least one shaft end.

10. The vacuum pump rotor according to claim 1, wherein the surface of at least one of the displacement elements is provided with an emergency operation coating.
